(19) United States
(12) Patent Application Publication
(10) Pub. No.: US 2022/0024531 A1
(43) Pub. Date: Jan. 27, 2022

(54) Lifting Device For The Translational Progressive Movement Of A Motor Vehicle

(71) Applicant: Michael Traut, Bergrheinfeld (DE)

(72) Inventor: Michael Traut, Bergrheinfeld (DE)

(21) Appl. No.: 17/284,587

(22) PCT Filed: Oct. 16, 2018
(86) PCT No.: PCT/DE2018/100849

§ 371 Date: Sep. 28, 2021

(51) Int. Cl. B62D 57/032; B62D 57/028; B60S 9/205

(52) U.S. Cl. CPC B62D 57/032; B60S 9/205; B62D 57/028

(57) ABSTRACT

A lifting device for the progressive movement of a motor vehicle, with a support plate (11) which is suitable for the releasable or fixed connection to an underbody of the motor vehicle, and with a lifting unit which is provided for raising the motor vehicle from a lowered position into a raised position. The lifting unit is arranged on a main sliding plate, wherein the main sliding plate and the support plate are interconnected movably relative to each other in a sliding plane (x-y) such that, in the raised position, owing to a relative movement between the support plate and the main sliding plate, the support plate is movable with the motor vehicle relative to the underlying surface in the sliding plane (x-y), and, in the lowered position, the main sliding plate is movable with the lifting unit relative to the underlying surface in the sliding plane (x-y).

### BACKGROUND OF THE INVENTION

The invention relates to a lifting device for the progressive movement of a motor vehicle, with a support plate which is suitable for the releasable or fixed connection to an underbody of the motor vehicle, and with at least one lifting unit which is provided for raising the motor vehicle from a lowered position, in which the motor vehicle touches down on an underlying surface, into a raised position.

The invention also relates to a motor vehicle having such a lifting device and a rotation unit and a locking unit for a lifting device.

Motor vehicles are required not only in road traffic but also off paved roads, in open, sometimes impassable terrain for the transport of vehicle occupants and/or goods, but also for construction or rescue operations and/or for exploring the terrain. When driving off-road, it can happen that the wheels that are usually provided for moving the motor vehicle, may slip due to lack of traction, e.g. on muddy or sandy ground, but also on ice or snow, and can no longer move the vehicle. Particularly in the case of sand or mud, it can also happen that the wheels of the vehicle dig in, which means that progressive movement is no longer possible. Another challenge when driving off-road is overcoming obstacles, e.g. a bump or edge. Depending on the height of the obstacle, crossing using the conventional wheel drive is not possible at all, or the vehicle underbody may touch down when attempting to cross the obstacle, as a result of which the motor vehicle is stuck on the obstacle and likewise cannot be moved any further.

Lifting devices for motor vehicles are already known from the prior art, which are intended to free the vehicle from such a state or a similar state in which the vehicle is stuck in or on the ground. In this case, the vehicle is usually lifted by means of hydraulic cylinders from the lowered (operating) position in which the vehicle contacts the ground with its wheels and is ready to drive, into a raised position in which one, several or all of the wheels no longer touch the ground.

For example, an off-road vehicle is known from DE 26 06 399 A1 under the chassis of which, that is, on the vehicle underbody, hydraulic cylinders configured as lifting cylinders are pivotably arranged, the bearing axes of which extend transversely to the longitudinal direction of the vehicle. The hydraulic cylinders attached to the vehicle are intended to enable moving, supporting, and lifting the vehicle. The lifting cylinders can be controlled automatically or manually from inside the vehicle. With the device described, however, actual or complete raising of the off-road vehicle is not possible, as a result of which obstacles cannot be crossed. And for progressive movement it is also required that the wheels contact the ground and even roll thereon. The lifting cylinder is merely used for pushing the vehicle, which means that lateral movement is also not implementable.

A supporting steering device and a walking device for a motor vehicle are known from CN 103 434 498. The supporting steering device comprises a hydraulic cylinder, the lower end of which is pivotably connected to a base plate for resting on the ground and the upper end of which is connected to a rotating plate arranged on the motor vehicle. As a result, the supporting steering device, if not in use, can be placed against the vehicle underbody and swiveled out if necessary, whereby the motor vehicle is lifted into a fully raised position in which all four wheels lose contact with the ground. The vehicle can then be rotated by 180° using the turntable, for example to perform a “U-turn.” The motor vehicle is additionally equipped with a walking device which comprises four separate “feet” which are intended to enable a walking movement by pivoting several plates and arms about respective pivot axes that connect these to one another. Such “walking” movement is, on the one hand, complicated in terms of control and almost impossible to achieve on uneven or slippery ground. Such a movement also leads to severe rocking of the motor vehicle, which reduces the comfort for the vehicle occupants.

Overall, the devices shown in the prior art are often not very reliable in use or are implemented in a complicated and costly manner, whereby particularly the small amount of space on the vehicle underbody is completely taken up and/or ground clearance is severely affected.

### SUMMARY OF THE INVENTION

It is therefore the object of the present invention to overcome the disadvantages of the prior art and to create a lifting device for moving a motor vehicle, which particularly makes it possible to free the motor vehicle from a stuck state to cross obstacles and to further increase overall maneuverability.

The object is achieved by a lifting device according to claim 1, a rotation unit for a lifting device according to claim 16, a locking unit for a lifting device according to claim 17, and a motor vehicle with a lifting device according to claim 18.

A lifting device according to the invention of the type described in more detail at the outset is characterized in that the at least one lifting unit is arranged on a main sliding plate, wherein the sliding plate and the support plate are interconnected movably relative to each other in a sliding plane such that, in the raised position, due to a relative movement between the support plate and the main sliding plate, the support plate is movable with the motor vehicle relative to the ground in the sliding plane, and, in the lowered position, the main sliding plate is movable with the at least one lifting unit relative to the ground in the sliding plane.

According to the invention, therefore, a lifting device is provided which can be permanently fixedly or detachably connected to the underbody of a motor vehicle by means of just a support plate. This allows later retrofitting of a motor vehicle with the lifting device according to the invention. Since the connection is designed to be detachable, the lifting device can also be variably mounted and dismantled as required or, in the event of a malfunction, removed for repair or replaced. The lifting unit intended for raising the motor vehicle is not directly arranged on the support plate, but on a main sliding plate which is substantially parallel to the support plate. The main sliding plate and the support plate are interconnected but can be moved or displaced in a sliding plane, that is, in a plane parallel to the underbody of the vehicle and/or parallel to the main sliding plate and the support plate themselves. The lifting unit, on the other hand, is configured for raising and/or lowering the motor vehicle perpendicular to the sliding plane. The lifting unit can be used to raise the motor vehicle from a lowered position, in which the motor vehicle contacts the ground, into a raised position or to lower it from the raised position into the lowered position.

In the raised position, in which the motor vehicle preferably has no more contact to the ground, a relative movement between the support plate and the main sliding plate results in an offset of the support plate, together with the motor vehicle fastened thereto, with respect to the ground. The lifting unit, which supports itself on the ground, and the main sliding plate fastened thereto remain stationary in their original position. In the lowered position, however, in which the motor vehicle contacts the ground and the lifting unit preferably has no contact with the ground, a relative movement between the support plate and the main sliding plate results in an offset of the main sliding plate together with the lifting unit fastened thereto, whereas the motor vehicle together with the support plate remains stationary in its original position.

According to the invention, a motor vehicle which is connected to the lifting device according to the invention can thus be moved in that the motor vehicle is raised by the lifting unit in a first step. Then a relative translational movement between the support plate and the main sliding plate is performed in a second step, for example along a longitudinal or transverse direction of the vehicle, whereby the motor vehicle is offset relative to the ground. Subsequently, the motor vehicle is lowered in the offset position by the lifting unit in a third step until it contacts the ground again. At the same time, the lifting unit is retracted, such that it no longer touches the ground. As a final fourth step, another relative translational movement between the support plate and the main sliding plate is performed in the sliding plane, whereby the main sliding plate returns to its initial position together with the at least one lifting unit. These four steps can be repeated as often as desired, whereby the motor vehicle can be moved over a desired distance without the driver or the occupants having to leave the vehicle.

Due to the translational sliding movement according to the invention of the support plate and the main sliding plate relative to one another, an offset of the motor vehicle relative to the ground within the sliding plane can be facilitated with just a minor design effort. Particularly, the components that carry the motor vehicle can do without additional pivotable or rotatable joints for progressive movement. The support plate and the main sliding plate are instead slidingly connected to one another. In order to take up as little space as possible under the vehicle or to affect ground clearance as little as possible, the lifting device has a low overall thickness of preferably at most 6 cm.

Advantageous embodiments are claimed in the dependent claims and will be explained in more detail below.

According to an advantageous embodiment of the lifting device according to the invention, the main sliding plate is connected to the support plate using at least one auxiliary sliding plate to form a movable connection, wherein the support plate is arranged between the main sliding plate and the at least one auxiliary sliding plate and movable in the sliding plane relative to the main sliding plate and the at least one auxiliary sliding plate.

Preferably, starting from the vehicle underbody towards the ground, initially at least one, particularly two, auxiliary sliding plates, then the support plate and lastly the main sliding plate are arranged, the latter being connected to the at least one lifting unit. The auxiliary sliding plates, the support plate, and the main sliding plate are substantially parallel to one another, wherein the support plate is slidingly movable between the auxiliary sliding plates and the main sliding plate.

According to a further development of this embodiment, the main sliding plate and the at least one auxiliary sliding plate are interconnected by means of spacer rods which pass through recesses arranged in the support plate.

The recesses arranged in the support plate and the spacer rods can jointly be configured for guiding and/or for limiting the movement of the support plate in the sliding plane relative to the main sliding plate.

Preferably, recesses are arranged within the support plate and spacer rods are arranged within the recesses. The at least one auxiliary sliding plate is connected, particularly firmly, to the spacer rods above the support plate and the main sliding plates are connected, particularly firmly, to the spacer rods below the support plate. The spacer rods can move translationally inside the recesses along a longitudinal direction of the vehicle or along a transverse direction of the vehicle, wherein the spacer rods are guided within the recesses and/or their movement is limited by the recesses. It is an advantage if the height of the spacer rods at least matches the height of the support plate or if the spacer rods are slightly higher than the support plate, such that free sliding between the support plate and the at least one auxiliary sliding plate and between the support plate and the main sliding plate is enabled.

In an optional embodiment, such a relative sliding movement can be supported by a lubricant system for forming a lubricant-including slide layer between the support plate and the main sliding plate and/or the support plate and the at least one auxiliary sliding plate.

The lubricant system is preferably arranged between the vehicle underbody and the support plate; particularly, lubricant lines can extend on the top side of the support plate facing the vehicle underbody and terminate at the at least one auxiliary sliding plate and/or the main sliding plate, such that lubricant supplied in the lubricant lines forms a lubricant layer between the support plate and the main sliding plate and/or between the support plate and the at least one auxiliary sliding plate. Additionally or alternatively to the lubricant system, the top side of the support plate facing the vehicle underbody and/or the bottom side of the support plate facing the ground and/or the bottom side of the at least one auxiliary sliding plate facing the support plate and/or the top side of the main sliding plate facing the support plate may at least partially be provided with a service life grease lubrication and/or a plastic slide layer, which in addition to lubrication is intended to reduce wear during the translational movements.

According to an advantageous embodiment of the invention, at least one longitudinal actuator for moving the main sliding plate along a longitudinal direction in the sliding plane is provided, which actuator is connected to the support plate via a first end section and to the main sliding plate via a second end section, particularly indirectly by means of a cable having deflection rollers, and at least one transverse actuator for moving the main sliding plate along a transverse direction in the sliding plane, which actuator is connected to the support plate via a first end section and to the main sliding plate via a second end section, particularly indirectly by means of a cable having deflection rollers.

A first end section of longitudinal or transverse actuators, which are preferably designed as hydraulic cylinders, is firmly connected to the support plate, particularly directly or indirectly. The second end section can be indirectly connected to the main sliding plate by means of a cable. This has the advantage that a linear longitudinal and transverse movement of the main sliding plate relative to the support plate can be implemented regardless of the orientation of the respective actuators by using one or multiple deflection rollers. For performing a uniform linear movement, the second end sections, particularly the cables, are centrally connected to a longitudinal or transverse edge of the main sliding plate.

But not only linear movements can be performed using the longitudinal or transverse actuators; in a particularly preferred further development of this embodiment, two longitudinal actuators can be provided for moving the main sliding plate along the longitudinal direction y and two transverse actuators can be provided for moving the main sliding plate along the transverse direction x, wherein the longitudinal actuators and the transverse actuators are connected to the support plate via their respective first end section and to an edge end of a longitudinal or transverse edge of the main sliding plate via their second end section, particularly indirectly by means of cables having deflection rollers, such that the main sliding plate can be rotated relative to the support plate by means of the longitudinal actuators and/or the transverse actuators.

Each actuator thus engages a corner of the main sliding plate assigned to it in that the respective second end sections of the longitudinal and transverse actuators are connected off center to the edge ends of the longitudinal and transverse edges of the main sliding plate, particularly indirectly by means of respective cables. For a linear movement of the main sliding plate in the longitudinal direction of the vehicle, the same force is applied to both longitudinal actuators, such that these move the main sliding plate and all components fastened thereto in a parallel and straight manner. If the main sliding plate is to be moved in the transverse direction of the vehicle, the respective process is performed on the transverse actuators. For a rotation of the main sliding plate, one longitudinal or transverse actuator is activated per longitudinal or transverse side, i.e. a force is applied to it, wherein the second end sections of the activated actuators are preferably connected to adjacent corners of the main sliding plate. A rotation of the main sliding plate can be implemented due to the asymmetrical application of force. Expediently, the recesses provided with the spacer rods arranged therein are adjusted in this embodiment in accordance with the rotation of the main sliding plate.

Furthermore, in an advantageous exemplary embodiment, each lifting unit has at least two linear actuators arranged opposite to one another, wherein a first end section of each linear actuator is articulated to the main sliding plate and a respective second end section is articulated to a foot element of the lifting unit, such that the foot element can be moved relative to the support plate and/or the main sliding plate along a lifting direction, perpendicular to the sliding plane, from a retracted position into an extended position. Expediently, the first end sections of the linear actuators are indirectly connected to the main sliding plate via a lifting unit support frame.

The linear actuators, which are preferably designed as hydraulic cylinders, are extended simultaneously and exert a lifting force on the respective foot element, whereby this element moves from the retracted position towards the ground. Subsequently, the foot element supports itself on the ground to raise the motor vehicle from a lowered position into a raised position. Due to the articulated joint of the linear actuators to the main sliding plate and the respective foot element, it is not necessary to arrange these elements perpendicular to the ground. Preferably, two linear actuators arranged opposite to one another rest against a bottom side of the main sliding plate facing the ground in the retracted position, that is, the linear actuators extend parallel to the main sliding plate and thus to the sliding plane. The articulated joints are preferably designed as pivot axes, about which the linear actuators pivot from the retracted position into the extended position and vice versa. In a completely extended position, the linear actuators form an acute angle with the main sliding plate, particularly an angle of about up to 60°. Since at least two linear actuators per lifting unit are arranged opposite to one another, particularly heavy motor vehicles or loads can be lifted because the linear actuators support each other for absorbing respective forces and moments.

In an advantageous embodiment of the invention, at least one stabilizing unit is provided for stabilizing the motor vehicle, particularly in the raised position, particularly for the function of overcoming obstacles, which unit comprises a stabilization actuator, wherein a first end section of the stabilization actuator is articulated to a stabilizing foot element, such that the stabilizing foot element can be moved relative to the support plate and/or the main sliding plate along a lifting direction, perpendicular to the sliding plane, from a retracted position into an extended position.

According to a further development of this embodiment, the at least one stabilizing unit has a stabilization actuator for extending the stabilizing unit, wherein a first end section of the stabilization actuator is articulated to the support plate and a second end section is articulated to the main sliding plate.

Preferably, four stabilizing units are each assigned to a corner area of the support plate, and their stabilization actuator, particularly configured as a hydraulic cylinder, is articulated to the support plate via a first end section. Similar to the lifting units described above, the stabilization actuator is also articulated to a stabilizing foot element via its second end section. The articulated joints can in this embodiment also be configured as pivot axes about which the respective end section of the stabilization actuator pivots. Unlike the lifting units described above, the stabilization actuator, in its fully extended position, forms an angle of 90° with the support plate, which allows keeping bending moments and transversal forces acting on the stabilization actuator as small as possible. The stabilization actuators can be extended by pivoting actuators which are preferably configured as hydraulic cylinders. Alternatively, the pivoting actuators can be driven by an electric motor.

The stabilizing units represent a third standing option besides the wheels of the motor vehicle and the lifting units to keep the motor vehicle in a raised position, preferably horizontally, even if the lifting units are in their retracted position. This embodiment allows translational progressive movement of the vehicle without requiring the wheels of the motor vehicle to contact the ground.

According to an expedient exemplary embodiment, it is an advantage for the function if a locking unit comprising one or multiple locking pawls and a locking actuator is assigned to at least one lifting unit and/or at least one stabilizing unit for securing the assigned lifting unit and/or stabilizing unit in the retracted position.

In a further development, the locking actuator is arranged on the main sliding plate and/or the support plate and indirectly connected via a cable, particularly a Bowden cable, to the one or multiple locking pawls. Expediently, the locking actuator is indirectly connected, i.e. via a locking pawl carrier, to the main sliding plate and/or the support plate. Particularly, the locking pawl carrier can be indirectly connected to the main sliding plate via the lifting unit support frame.

The locking unit is not absolutely necessary for the functioning of each lifting unit and/or the stabilizing units, but it can ensure in the form of a safety system that the lifting units and/or the stabilizing units remain in their retracted positions if the pressure in the hydraulic system has dropped after a longer period of non-use and the foot elements and/or the stabilizing foot elements would lower the respective hydraulic cylinder into the extended position due to their own weight. Furthermore, the locking unit prevents “rattling” of the foot elements and/or stabilizing foot elements, which could occur during fast travel due to uneven ground.

The locking pawls, which are configured as levers, can preferably be operated using a return spring and a Bowden cable with a connected Bowden cable actuator. The one end of the lever presses against the foot element and/or stabilizing foot element and the other end can be pulled by the Bowden cable. Alternatively, rotational actuators could also be mounted directly to the locking pawl and replace the Bowden cables in this way.

According to a particularly maneuverable embodiment of the invention, the lifting device comprises a rotation unit which is configured for rotating the motor vehicle and the support plate relative to one another about an axis of rotation.

In an advantageous further development, the rotation unit can be arranged between the vehicle underbody and the support plate and comprises a rotating bearing and a rotation actuator, wherein the rotating bearing can be connected via a first bearing section to the vehicle underbody and via a second bearing section to the support plate. Expediently, the rotation unit is connected to the vehicle underbody by means of a rotation frame and the first section of the rotating bearing is indirectly, that is, via the rotation frame, connected to the vehicle underbody.

The rotation actuator can for example be fastened to the rotation frame and directly adjoin the rotating bearing to drive the same, e.g. by means of a friction-locking contact, particularly a platter bearing. According to a particularly preferred further development of this embodiment, it is expedient, however, that the rotation actuator is arranged on the bottom side of the support plate facing the ground and is indirectly connected to the rotating bearing by means of a belt. An embodiment with both rotation actuators arranged in the respective positions is conceivable as well. The rotation actuators themselves can preferably be a drive motor. The rotation unit allows turning in narrow surroundings by any desired angular degrees, e.g. by 180°.

In addition to the progressive movement of a motor vehicle, it is also conceivable to use the lifting device according to the invention in one of the variants described above for transporting or moving other loads.

The invention is also directed at a rotation unit for a lifting device, particularly according to one of the above embodiments. According to the invention, the rotation unit can be arranged between the vehicle underbody of a motor vehicle and the lifting device, such that the motor vehicle and the lifting device can be rotated relative to one another about an axis of rotation, wherein the rotation unit comprises a rotating bearing and a rotation actuator and the rotating bearing can be connected to the vehicle underbody via a first bearing section, particularly indirectly by means of a rotation frame, and to the support plate via a second bearing section.

Furthermore, a locking unit for a lifting device, particularly according to one of the above embodiments, is included in the scope of the inventive idea. According to the invention, the locking unit is assigned to a lifting unit and/or a stabilizing unit of the lifting device and comprises one or multiple locking pawls and a locking actuator for securing the assigned lifting unit and/or stabilizing unit, wherein the locking actuator is connected to the one or multiple locking pawls by means of a cable, particularly a Bowden cable.

Finally, the invention is directed at a motor vehicle having a lifting device according to one of the embodiments described above. A drive unit driving the at least one longitudinal actuator and/or the at least one transverse actuator and/or the at least two linear actuators and/or the at least one stabilization actuator and/or the at least one pivoting actuator and/or the at least one rotation actuator can be arranged in a loading space or in the engine compartment of the motor vehicle.

A control unit which is provided for automatic control and readjustment or fine tuning of the lifting device can be arranged inside the motor vehicle, preferably inside a loading space and/or trunk and/or engine compartment. Particularly, each lifting unit and/or each stabilizing unit can be activated individually, which is why the lifting height of each foot element and/or stabilizing foot element can be controlled individually. This ensures that the motor vehicle can be brought into a horizontal orientation when being lifted, even if the ground is very uneven or inclined. The orientation of the motor vehicle can, either selectively or if required, be manually controlled by the user, particularly the driver or another vehicle occupant, or it can be taken over automatically by an electronic valve control system, in that inclination sensors detect the orientation of the motor vehicle. In both cases, it is not necessary that the user or the vehicle occupants get out of the vehicle.

The vehicle is initially raised to move the motor vehicle out of a stuck situation or to climb over an obstacle. In the raised position, the motor vehicle is moved laterally by a relative movement of the support plate in relation to the main sliding plate. After the vehicle has performed a longitudinal or transverse movement after being raised, it is lowered again. In the lowered position, the wheels can either find enough traction to travel on or the sequence of movements described is repeated. To this end, it is initially required that the main sliding plate be moved back in a direction opposite to the longitudinal or transverse movement performed before, as long as the lifting units are retracted and the wheels contact the ground. Then the motor vehicle can be raised again and the sequence described can be repeated as often as desired until the vehicle has been moved to a place at which it can move by its wheel drive on the ground.

In the case that the ground is very uneven or if obstacles are to be overcome, the stabilization actuators must be activated via the control system. If the vehicle is to “climb” over an obstacle, for example, it is first raised and then moved laterally as described. If the vehicle would then be lowered again, sections of the vehicle underbody and/or the lifting device could be placed on the obstacle, which would render a successive return movement of the main sliding plate impossible. In addition, there is the risk of an unfavorable imbalance of the vehicle. Depending on the position and orientation of the motor vehicle to the obstacle and/or to the ground, one, two, three, or four stabilization actuators can extend, align the vehicle horizontally and carry it in this orientation, while the lifting units are moved back into their retracted positions for the return movement of the main sliding plate into its retracted position. The vehicle can be leveled automatically by means of the control system and respective sensors. In the next iteration, when the lifting units move into their extended position again and after the main sliding plate has returned to its original position, the stabilization actuators are partially or completely retracted to avoid a collision with the obstacle, depending on the condition of the ground and/or the obstacle.

### BRIEF DESCRIPTION OF THE SEVERAL VIEWS OF THE DRAWINGS

Further details, features, (sub)combinations of features, advantages, and effects based on the invention can be derived from the following description of preferred exemplary embodiments of the invention and the drawings. Wherein, schematically,

FIG. 1 shows a perspective view of a first exemplary embodiment of a lifting device according to the invention with a support plate and a main sliding plate,

FIG. 2a shows a perspective view of the support plate and the main sliding plate of the first exemplary embodiment of the lifting device according to the invention from FIG. 1,

FIG. 2b shows a detailed perspective view of the support plate and the main sliding plate from FIG. 2a,

FIG. 3 shows a plan view of the lifting device from FIG. 1 with an additional lubricant system,

FIG. 4 shows a perspective view of a first exemplary embodiment of a lifting device according to the invention according to FIG. 1 with extended lifting units and stabilizing units,

FIG. 5 shows a detailed view of a lifting unit of the first exemplary embodiment according to FIG. 1,

FIG. 6 shows a plan view of a second exemplary embodiment of the lifting device according to the invention,

FIG. 7 shows a perspective view of a third exemplary embodiment of a lifting device according to the invention with a rotation unit, and

FIG. 8 shows an exemplary perspective view of an optional protective cover.

All figures are purely exemplary and only intended to help understand the invention. Like elements always have like reference numerals, which is why they are typically described only once. The embodiments shown are for the most part symmetrical with respect to their longitudinal and transverse axes. For the sake of clarity, elements that mirror on these axes are mostly identified only once by one reference numeral in the figures.

### DETAILED DESCRIPTION OF THE INVENTION

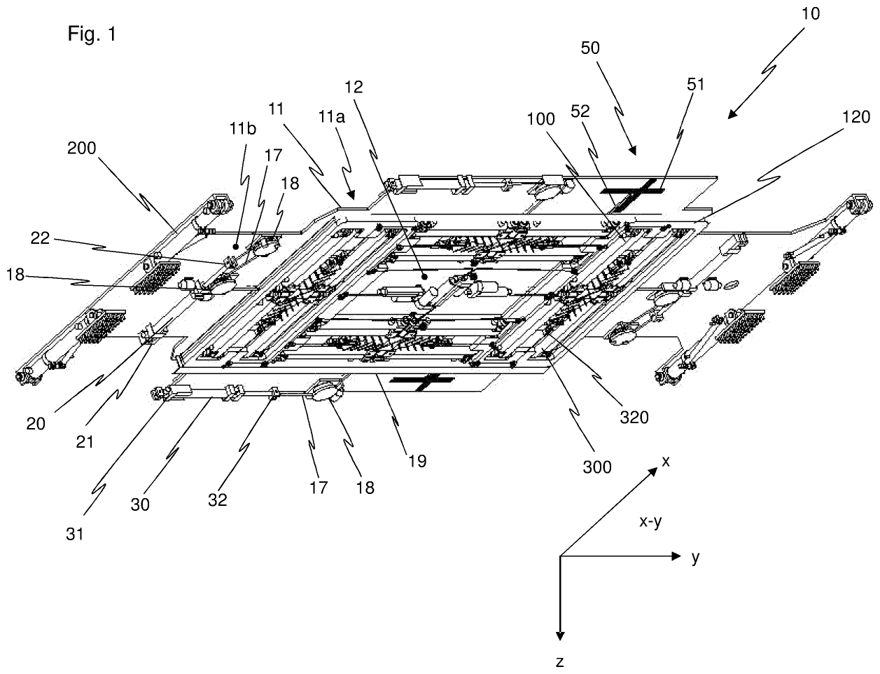

FIG. 1 shows a first exemplary embodiment of a lifting device 10 according to the invention for progressive movement of a motor vehicle, viewed from the ground towards the vehicle underbody. The lifting device 10 substantially comprises a support plate 11, a main sliding plate 12, and four lifting units 100. The entire lifting device 10 is of a flat design, so that it occupies as little space as possible under the vehicle or affects ground clearance as little as possible. The support plate 11 is the only component which is fastened to the vehicle underbody of the motor vehicle with its top side 11a, not visible here, that faces the vehicle underbody. The main sliding plate 12 extends substantially parallel to the support plate 11 or the vehicle underbody and/or the ground on the bottom side 11b of the support plate 11, which faces the ground not visible here. The main sliding plate 12 and the support plate 11 can be moved relative to one another in a sliding plane x-y, which is spanned by the transverse direction x and the longitudinal direction y. The four lifting units 100 are configured for raising the motor vehicle along a lifting direction z from a lowered position, in which the motor vehicle contacts the ground, into a raised position, in which the motor vehicle preferably has no contact with the ground and can itself be moved in the opposite direction from a retracted position into an extended position. Due to the rhomboid arrangement of the lifting units 100 on the main sliding plate 12, a greater lifting height can be implemented along the lifting direction z. The four lifting units 100 are each shown in their respective completely extended position and connected to the bottom side of the main sliding plate 12 facing the ground by means of a lifting unit support frame 120. A stabilizing unit 200 is arranged on each of the four outer corners of the support plate 11, which like the lifting units 100 are shown here in their completely retracted position, but they can be moved into an extended position as well. The lifting units 100 are each secured in their retracted position by a locking unit 300 comprising locking pawls 320.

For moving the main sliding plate 12 relative to the support plate 11 in the sliding plane x-y, two longitudinal actuators 20 and two transverse actuators 30 are arranged on the bottom side 11b of the support plate 11, each of which being designed as linear hydraulic cylinders in this case. The longitudinal actuators 20 are provided for moving, particularly for pulling the main sliding plate 12 along the longitudinal direction y. The transverse actuators 30 are provided for moving, particularly for pulling the main sliding plate 12 along the transverse direction x. Both the longitudinal actuators 20 and the transverse actuators 30 are aligned vertically to their respective pulling direction to position them as space savingly as possible. To allow the deflection of the pulling direction required here, a second end section 32 of a transverse actuator 30 and a second end section 22 of a longitudinal actuator 20 are each connected to an end of a pulling cable 17, particularly a steel cable, which is deflected by means of various deflection rollers 18. The other end of the pulling cable 17 is connected centrally to a transverse edge, in this case indirectly via the lifting unit support frame 120, or connected centrally to a longitudinal edge, in this case indirectly via a cable carrier 19. The respective first end section 31 of the transverse actuators 30 and the respective first end section 21 of the longitudinal actuators 20 are firmly arranged on the support plate 11. The cable carriers 19 are each once again fastened to the lifting unit support frames 120.

In the raised position of the motor vehicle, by activating a longitudinal actuator 20 or a transverse actuator 30, the support plate 11 and together with it the motor vehicle fastened to the support plate 11 are moved, particularly pulled, in the respective direction. Retracting a longitudinal actuator 20 or a transverse actuator 30 causes a pulling force to be applied to the pulling cable 17 connected to the respective second end section 22 or 32. At the same time, the respective second end section 22 or 32 of the opposing longitudinal actuator 20 or transverse actuator 30 is extended. This can be achieved, for example, by a respective circuit of hydraulic valves or control levers. The respectively adjacent longitudinal actuators 20 or transverse actuators 30 can also be activated by means of this circuit to follow the offset between support plate 11 and main sliding plate 12.

If the exact positioning and travel of the linear longitudinal and transverse movements must be determined exactly, e.g. for an automatic, electronic control system, or if the user, particularly the driver or the vehicle occupants need an optical display of the respective position of the main sliding plate 12, displacement sensors 50 can be attached on the support plate 11 and preferably on the cable carrier 19 which can provide both electronic signals for the control unit and an optical display since they are attached so that they are visible from outside. The displacement sensors 50 comprise incremental sensor strips 51 arranged on the support plate 11 for the longitudinal direction y and the transverse direction x and incremental transmitters 52 arranged on the cable carrier 19 which can move longitudinally or transversely over the incremental sensor strips 51 during linear movement and thereby generate displacement signals. In addition, the user, particularly the driver or the vehicle occupants can be given a complete image of the situation under the vehicle without anyone having to leave the vehicle, in that cameras with integrated lamps are arranged at various positions of the support plate 11 and positioned such that each functional component is filmed and illuminated and the images are transmitted to screens in the vehicle interior.

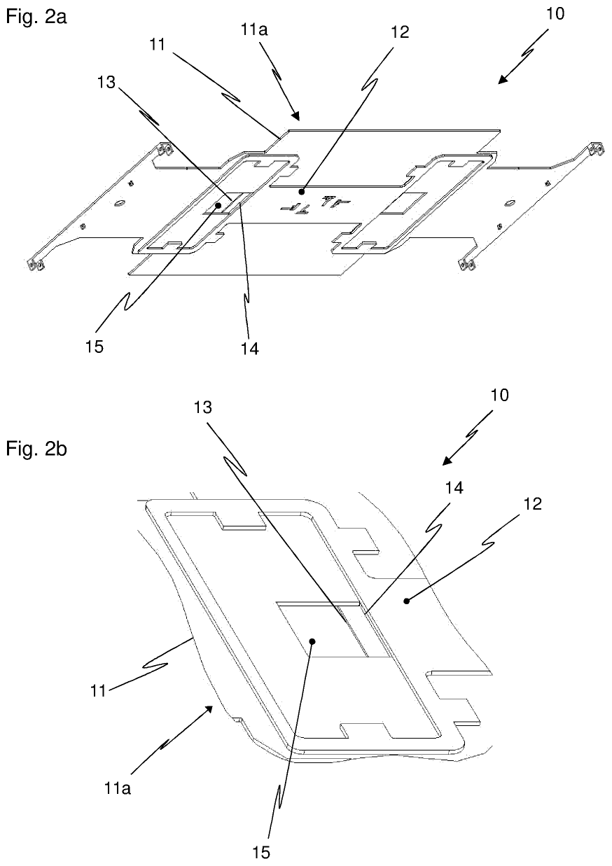

FIGS. 2a and 2b each show a perspective view of the support plate 11 and the main sliding plate 12 of the first exemplary embodiment of the lifting device 10 according to the invention from FIG. 1, viewed from the ground towards the vehicle underbody. FIG. 2b shows a detailed view of FIG. 2a. It is well visible that, opposite the main sliding plate 12, two auxiliary sliding plates 13 are arranged on the top side 11a of the support plate 11 facing the vehicle underbody, which sliding plates extend parallel to the support plate 11 and to the main sliding plate 12. In other words, the support plate 11 is slidingly arranged between the auxiliary sliding plates 13 located above it and the main sliding plate 12 located below it. The auxiliary sliding plates 13 and the main sliding plate 12 are each firmly connected by a spacer rod 14, wherein the spacer rod 14 is arranged inside a respective, particularly cross-shaped, recess 15 of the support plate 11. The auxiliary sliding plates 13 are designed of a low thickness, but their longitudinal and transverse extensions are sufficiently great that they cannot fall through the recesses 15 in any condition of movement.

FIG. 3 shows the lifting device 10 viewed from the vehicle underbody towards the ground. For better understanding of the orientation and dimensions of the lifting device 10, the vehicle axles 1 and wheels 2 are schematically indicated. Starting from the vehicle underbody, the two auxiliary sliding plates 13 are visible first. The support plate 11 with its cross-shaped recesses 15, which are partially shown hatched, follows at the respective bottom sides of the auxiliary sliding plates 13. A spacer rod 14, also shown in dashed lines, is arranged inside each of the cross-shaped recesses 15, which spacer rod can move translationally in the longitudinal or transverse directions within the cross-shaped recesses 15. The main sliding plate 12, which is clearly visible herein through the cross-shaped recesses 15, follows at the lowest position and is firmly connected to the spacer rods 14. As can be derived from the view, the longitudinal and transverse dimensions of the spacer rod 14 approximately match the dimensions of the cross-shaped recess 15, whereby said recess is on the one hand suitable for guiding the spacer rod 14 and on the other hand specifies a limitation or stop of a relative movement of the support plate 11 in relation to the main sliding plate 12 in the longitudinal direction y and the transverse direction x.

Preferably, the height of the spacer rod 14 is slightly greater than that of the support plate 11, such that the support plate 11 can slide with low friction relative to the auxiliary sliding plates 13 and the main sliding plate 12. FIG. 3 also shows a lubricant system 16 for further reduction of friction, the lubricant lines of which extend on the top side 11a of the support plate 11 facing the vehicle underbody. The lubricant lines can form branches into holes located under the lubricant lines in the support plate 11 at specific points. In this way, lubricant layers can be formed using the lubricant system 16, both between the support plate 11 and the auxiliary sliding plates 13 and between the support plate 11 and the main sliding plate 12.

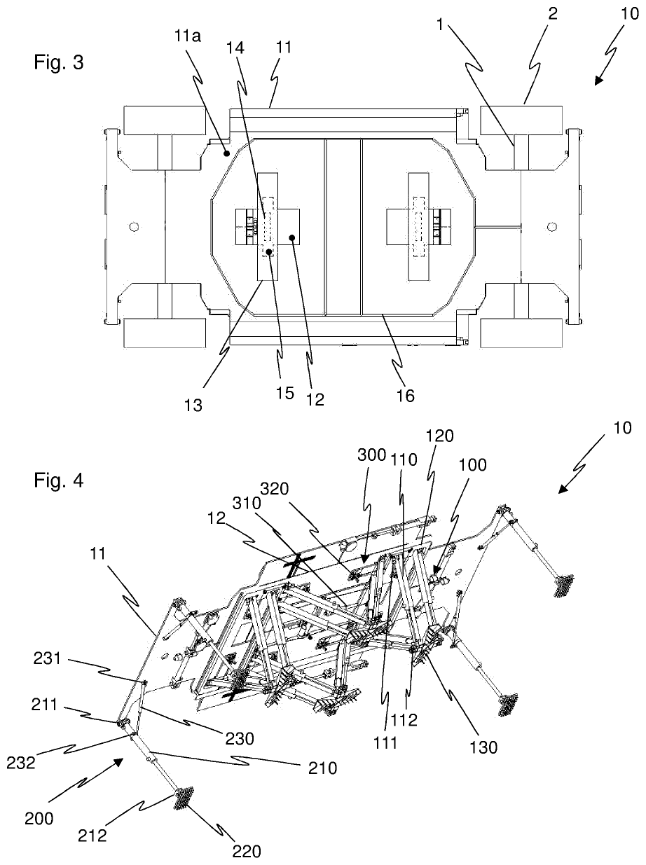

FIG. 4 also shows a schematic perspective view of the first exemplary embodiment of the lifting device 10 according to the invention. According to the illustration, both the four lifting units 100 and the four stabilizing units 200 are shown in their fully extended positions. The locking pawls 320 of the locking unit 300 are unlocked, the main sliding plate 12 is located in a central starting position. In this position of the lifting device 10, the motor vehicle is in a raised position in which the motor vehicle wheels 2 (not shown here) no longer contact the ground, the motor vehicle is solely carried by the stabilizing units 200.

Each stabilizing unit 200 comprises a stabilization actuator 210, the first end section 211 of which is articulated to the support plate 11 by means of a pivot axis, and a stabilizing foot element 220 is arranged on the second end section 212 of the actuator. The stabilizing unit 200 can be pivoted out into an orientation perpendicular to the support plate 11 by means of a pivoting actuator 230, the first end section 231 is articulated to the support plate 11 by means of a pivot axis and the second end section 232 of which is also articulated to the stabilization actuator 210. The stabilizing foot element 220 is likewise articulated to the second end section 212 of the stabilization actuator 210, enabling it to compensate uneven spots of the ground. Optionally, the stabilization actuators 210 can be supported by pivotable and extendable linear guides (not shown here) for absorbing any transversal forces.

Each lifting unit 100 is connected to the main sliding plate 12 by means of a lifting unit support frame 120 and comprises four linear actuators 110, the respective first end sections 111 of which are articulated to the lifting unit support frame 120 via a pivot axis and shown in their pivoted out positions in FIG. 4. A foot element 130 is arranged on the respective second end section 112 of the linear actuators 110 and can also be pivoted about a pivot axis.

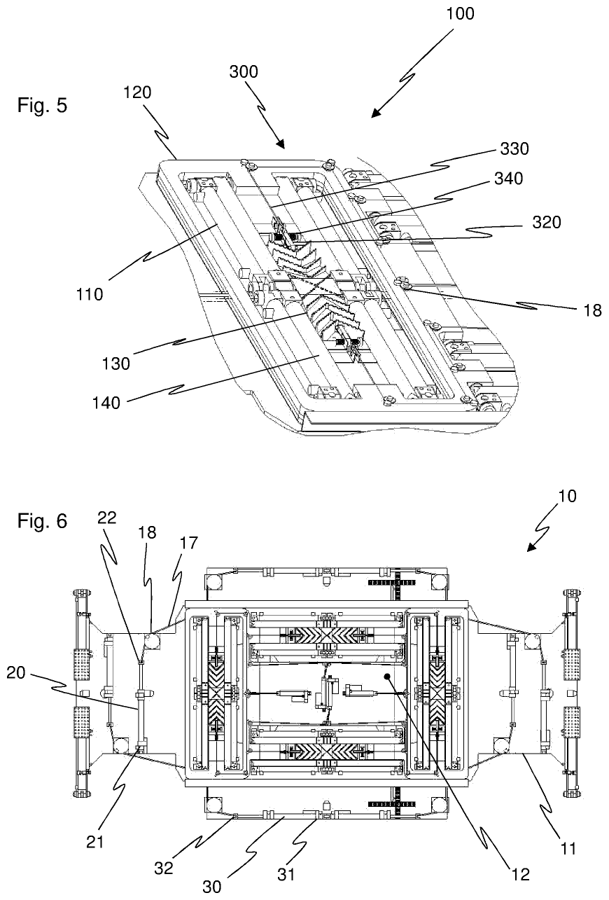

FIG. 5 shows a detailed view of lifting unit 100 with lifting unit support frame 120 of the first exemplary embodiment of the lifting device 10 according to the invention. The four linear actuators 110 are guided by means of one linear guide 140 each, which extend parallel to the linear actuators 110 configured as hydraulic cylinders as well as pivotable about respective pivot axes and extendable. The linear guides 140 are to absorb transversal forces and bending moments, such that these are not transmitted to the linear actuators 110. In an alternative embodiment not shown for more lightweight vehicles, it is conceivable to just use two linear actuators 110 without linear guides 140 instead of four linear actuators 110 per lifting unit 100. In this embodiment, the foot elements 130 can be designed in two parts resting on both sides against the linear actuators 110 to implement as flat a design as possible.

The lifting unit 100 is secured in the retracted position by the locking unit 300. To this end, the foot element 130 is held by two opposing locking pawls 320. Each locking pawl 320 can be pivoted about a pivot axis and is configured like a lever and held by a Bowden cable 330 in the closed position shown here. The Bowden cables 330 are conducted via multiple deflection rollers 18 to a locking actuator 310, particularly a linear actuator, which is arranged on the main sliding plate 12 (see FIG. 4). By activating the locking actuator 310, that is, when the actuator extends, the tension on the Bowden cable 330 is reduced. Therefore, return springs 340, e.g. torsion springs, but also linear helical compression or tension springs or similar spring can cause the locking pawls 320 to open and in this way to release the respective lifting unit 100.

FIG. 6 shows a second exemplary embodiment of the lifting device 10 according to the invention. This embodiment comprises two transverse actuators 30 or longitudinal actuators 20 for each transverse edge or longitudinal edge of the support plate 11, respectively. Unlike the first embodiment, the second end sections 32, 22 of the actuators 30, 20 are connected out-of-center via pull cables 17 and deflection rollers 18 to a respective end of the longitudinal edge or transverse edge of the main sliding plate 12. This allows both linear movement, i.e. a translational offset, of the support plate 11 relative to the main sliding plate 12 and a rotation of the support plate 11 relative to the main sliding plate 12 by any desired angular degrees via an electronic and closed-loop control of all eight actuators 20, 30. The recesses 15 (not visible here) arranged in the support plate 11 do not have a cross shape in this embodiment, but have an approximately oval shape. The embodiment shown provides the option to rotate the motor vehicle on little space relative to the ground without increasing the overall height or thickness of the lifting device 10.

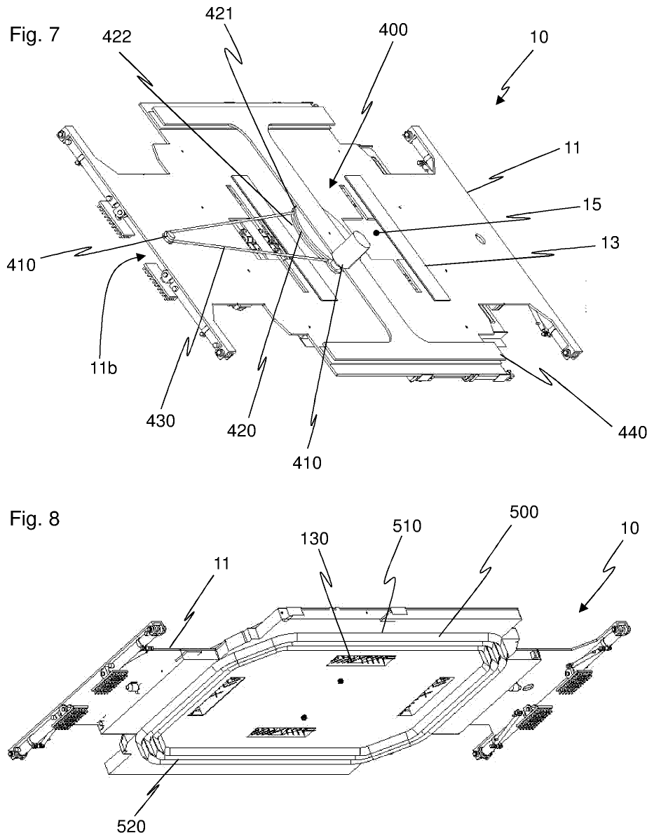

FIG. 7 is a third exemplary embodiment of the lifting device 10 according to the invention, viewed from the ground towards the vehicle underbody. This embodiment also allows rotating the motor vehicle by desired angular degrees relative to the ground. Compared to the first exemplary embodiment, the third exemplary embodiment comprises an additional rotation unit 400 for rotation, having a rotation frame 440, a rotating bearing 420, particularly configured as a platter bearing, and one or, alternatively, two rotation actuators 410. Instead of the support plate 11, the rotation frame 440 is firmly or detachably connected to the motor vehicle or its vehicle underbody, wherein a first bearing section 421 of the rotating bearing 420 is connected to the rotation frame 440 and therefore indirectly to the vehicle underbody and a second bearing section 422 is connected to the support plate 11. Rotation of the rotating bearing 420 and thus of the rotation frame 440 relative to the support plate 11 can be performed by means of the rotation actuators 410, which are particularly configured as drive motors. To this end, a rotation actuator 410 suitable for driving the rotating bearing 420 by means of friction-locking contact or, for example, by toothing on the rotating bearing 420 and the motor shaft, can be fastened to the rotation frame 440. Alternatively or additionally, a rotation actuator 410 is fastened to the bottom side 11b of the support plate 11 facing the ground, wherein the drive shaft with a drive pinion passes through a hole in the support plate 11. The torque can be transmitted from the drive shaft by means of a belt 430, such as a chain, a toothed belt, or a V-belt.

Finally, FIG. 8 shows an optional protective cover 500 for a lifting device 10, viewed from the ground towards the vehicle underbody. The protective cover 500 encloses all movable elements located under the support plate 11 except for the foot elements 130. The protective cover 500 is fastened to the support plate 11 at least at its circumferential regions 510 and comprises a rigid material which is interrupted by movable elastic pleats 520, allowing relative movement of the protective cover 500 in all three spatial directions, particularly in the lifting direction z, along a longitudinal direction y, and along a transverse direction x. Alternatively, the protective cover 500 can completely be made of an elastic material with or without additional elastic pleats.

### LIST OF REFERENCE NUMERALS

1 motor vehicle axle
2 motor vehicle wheel
10 lifting device
11 support plate
11a top side of the support plate
11b bottom side of the support plate
12 main sliding plate
13 auxiliary sliding plate
14 spacer rod
15 recesses
16 lubricant system
17 cable/pull cable
18 deflection roller
19 cable carrier
20 longitudinal actuator
21 first end section of the longitudinal actuator
22 second end section of the longitudinal actuator
30 transverse actuator
31 first end section of the transverse actuator
32 second end section of the transverse actuator
50 displacement sensor
51 incremental sensor strip
52 incremental transmitter
100 lifting unit
110 linear actuator
111 first end section of the linear actuator
112 second end section of the linear actuator
120 lifting unit support frame
130 foot element
140 linear guide
200 stabilizing unit
210 stabilization actuator
211 first end section of the stabilization actuator
212 second end section of the stabilization actuator
220 stabilizing foot element
230 pivoting actuator
231 first end section of the pivoting actuator
232 second end section of the pivoting actuator
300 locking unit
310 locking actuator
320 locking pawl
330 Bowden cable
340 return spring
400 rotation unit
410 rotation actuator
420 rotating bearing
421 first bearing section
422 second bearing section
430 belt
440 rotation frame
500 protective cover
510 circumferential region
520 elastic pleats
y longitudinal direction
x transverse direction
z lifting direction
x-y sliding plane

1. A lifting device (10) for progressive movement of a motor vehicle, having
a support plate (11) which is suitable for detachable or fixed connection to a vehicle underbody of the motor vehicle, and
at least one lifting unit (100), which is provided for raising the motor vehicle from a lowered position, in which the motor vehicle sits on a ground, into a raised position,
characterized in that
the at least one lifting unit (100) is arranged on a main sliding plate (12), wherein the main sliding plate (12) and the support plate (11) are connected to one another for relative movement in a sliding plane (x-y), such that, due to a relative movement between the support plate (11) and the main sliding plate (12),
the support plate (11) is movable in the raised position with the motor vehicle relative to the ground in the sliding plane (x-y), and
the support plate (11) is movable in the lowered position with the at least one lifting unit (100) relative to ground in the sliding plane (x-y).

2. The lifting device (10) according to claim 1,
characterized in that
the main sliding plate (12) is connected to the support plate (11) using at least one auxiliary sliding plate (13) to form a movable connection, wherein the support plate (11) is arranged between the main sliding plate (12) and the at least one auxiliary sliding plate (13) and movable in the sliding plane (x-y) relative to the main sliding plate (12) and the at least one auxiliary sliding plate (13).

3. The lifting device (10) according to claim 2,
characterized in that
the main sliding plate (12) and the at least one auxiliary sliding plate (13) are connected to one another by spacer rods (14) which pass through recesses (15) arranged in the support plate (11).

4. The lifting device (10) according to claim 3,
characterized in that
the recesses (15) arranged in the support plate (11) and the spacer rods (14) can jointly be configured for guiding or for limiting the movement of the support plate (11) in the sliding plane (x-y) relative to the main sliding plate (12).

5. The lifting device (10) according to claim 4,
characterized by
a lubricant system (16) for forming a lubricant-including slide layer between the support plate (11) and the main sliding plate (12) or the support plate (11) and the at least one auxiliary sliding plate (13).

6. The lifting device (10) according to claim 1,
characterized by
at least one longitudinal actuator (20) for moving the main sliding plate (12) along a longitudinal direction (y) in the sliding plane (x-y), which actuator is connected to the support plate (11) via a first end section (21) and to the main sliding plate (12) via a second end section (22), and at least one transverse actuator (30) for moving the main sliding plate (12) along a transverse direction (x) in the sliding plane (x-y), which actuator is connected to the support plate (11) via a first end section (31) and to the main sliding plate (12) via a second end section (32).

7. The lifting device (10) according to claim 6,
characterized in that
four longitudinal actuators (20) are provided for moving the main sliding plate (12) along the longitudinal direction (y), and four transverse actuators (30) are provided for moving the main sliding plate (12) along the transverse direction (x), wherein the second end sections (22, 32) of the two longitudinal actuators (20) and the two transverse actuators (30) are connected to a respective edge end of a longitudinal or transverse edge of the main sliding plate (12), such that the main sliding plate (12) can be rotated relative to the support plate (11) by means of the longitudinal actuators (20) and/or the transverse actuators (30).

8. The lifting device (10) according to claim 1,
characterized in that
each lifting unit (100) has at least two linear actuators (110) arranged opposite to one another, wherein a first end section (111) of each linear actuator (110) is articulated to the main sliding plate (12), and a respective second end section (112) is articulated to a foot element (130) of the lifting unit (100), such that the foot element (130) can be moved relative to the support plate (11) or the main sliding plate (12) along a lifting direction (z), perpendicular to the sliding plane (x-y), from a retracted position into an extended position.

9. The lifting device (10) according to claim 1,
characterized by
at least one stabilizing unit (200), which comprises a stabilization actuator (210) for stabilizing the motor vehicle, wherein a first end section (211) of the stabilization actuator (210) is articulated to the support plate (11) and a second end section (212) of the stabilization actuator (210) is articulated to a stabilizing foot element (220), such that the stabilizing foot element (220) can be moved relative to the support plate (11) or the main sliding plate (12) along a lifting direction (z), perpendicular to the sliding plane (x-y), from a retracted position into an extended position.

10. The lifting device (10) according to claim 9,
characterized in that
the at least one stabilizing unit (200) comprises a pivoting actuator (230) for pivoting out the stabilizing unit (200), wherein a first end section (231) of the pivoting actuator (230) is articulated to the support plate (11) and a second end section (232) is articulated to the stabilization actuator (210).

11. The lifting device (10) according to claim 9,
characterized in that
a locking unit (300) comprising one or multiple locking pawls (320) and a locking actuator (310) is assigned to at least one lifting unit (100) or at least one stabilizing unit (200) for securing the assigned lifting unit (100) or stabilizing unit (200) in the retracted position.

12. The lifting device (10) according to claim 11,
characterized in that
the locking actuator (310) is arranged on the main sliding plate (12) and/or the support plate (11) and indirectly connected via a cable to the one or multiple locking pawls (320).

13. The lifting device (10) according to claim 1,
characterized in that
the lifting device (10) comprises a rotation unit (400), which is configured for rotating the motor vehicle and the support plate (11) or the main sliding plate (12) relative to one another.

14. The lifting device (10) according to claim 13,
characterized in that
the rotation unit (400) can be arranged between the vehicle underbody and the support plate (11) and comprises a rotating bearing (420) and a rotation actuator (410), wherein the rotating bearing (420) can be connected via a first bearing section (421) to the vehicle underbody, and via a second bearing section (422) to the support plate (11).

15. The lifting device (10) according to claim 14,
characterized in that
the rotation actuator (410) is arranged on the support plate (11) and indirectly connected to the rotating bearing (420) by means of a belt (430).

16. A rotation unit (400) for a lifting device (10)
characterized in that
the rotation unit (400) can be arranged between the vehicle underbody of a motor vehicle and the lifting device (10), such that the motor vehicle and the lifting device (10) can be rotated relative to one another about an axis of rotation, wherein the rotation unit (400) comprises a rotating bearing (420) and a rotation actuator (410) and the rotating bearing (420) can be connected to the vehicle underbody via a first bearing section (421) and to the support plate (11) via a second bearing section (422).

17. A locking unit (300) for a lifting device (10),
characterized in that
the locking unit (300) is assigned to a lifting unit (100) or a stabilizing unit (200) of the lifting device (10) and comprises one or multiple locking pawls (320) and a locking actuator (310) for securing the assigned lifting unit (100) or stabilizing unit (200), wherein the locking actuator (310) is connected to the one or multiple locking pawls (320) by means of a cable.

18. A motor vehicle lifting device (10) according to claim 6,
characterized in that
a drive unit driving the at least one longitudinal actuator (20) or the at least one transverse actuator (30) and/or the at least two linear actuators (110) and/or the at least one stabilization actuator (210) and/or the at least one pivoting actuator (230) and/or the at least one locking actuator (310) and/or the at least one rotation actuator (410) can be arranged in a loading space and/or trunk and/or engine compartment of the motor vehicle.
